(19) United States
(12) Patent Application Publication
(10) Pub. No.: US 2022/0114494 A1
(43) Pub. Date: Apr. 14, 2022

(54) MODEL-AGNOSTIC APPROACH TO INTERPRETING SEQUENCE PREDICTIONS

(71) Applicant: Feedzai - Consultadoria e Inovação Tecnológica, S.A., Coimbra (PT)

(72) Inventors: João Pedro Bento Sousa, Leiria (PT); Pedro dos Santos Saleiro, Lisbon (PT); André Miguel Ferreira da Cruz, Vila do Conde (PT); Pedro Gustavo Santos Rodrigues Bizarro, Lisbon (PT)

(21) Appl. No.: 17/500,310

(22) Filed: Oct. 13, 2021

Related U.S. Application Data
(60) Provisional application No. 63/091,804, filed on Oct. 14, 2020.

(30) Foreign Application Priority Data
Oct. 11, 2021 (PT) 117509
Oct. 12, 2021 (EP) 21202300.6

(51) Int. Cl. G06N 20/00

(52) U.S. Cl. CPC G06N 20/00

(57) ABSTRACT

A series of sequential inputs and a prediction output of a machine learning model, to be analyzed for interpreting the prediction output, are received. An input included in the series of sequential inputs is selected to be analyzed for relevance in producing the prediction output. Background data for the selected input of the series of sequential inputs to be analyzed is determined. The background data is used as a replacement for the selected input of the series of sequential inputs to determine a plurality of perturbed prediction outputs of the machine learning model. A relevance metric is determined for the selected input based at least in part on the plurality of perturbed prediction outputs of the machine learning model.

### CROSS REFERENCE TO OTHER APPLICATIONS

This application claims priority to U.S. Provisional Patent Application No. 63/091,804 entitled A MODEL-AGNOSTIC APPROACH TO INTERPRETING SEQUENCE PREDICTIONS filed Oct. 14, 2020, which is incorporated herein by reference for all purposes.

This application claims priority to Portugal Provisional Patent Application No. 117509 entitled A MODEL-AGNOSTIC APPROACH TO INTERPRETING SEQUENCE PREDICTIONS filed Oct. 11, 2021, which is incorporated herein by reference for all purposes.

This application claims priority to European Patent Application No. 21202300.6 entitled A MODEL-AGNOSTIC APPROACH TO INTERPRETING SEQUENCE PREDICTIONS filed Oct. 12, 2021, which is incorporated herein by reference for all purposes.

### BACKGROUND OF THE INVENTION

Machine learning (ML) involves the use of algorithms and models built based on sample data, known as training data, in order to make predictions without being explicitly programmed to do so. ML has been increasingly used for automated decision-making, allowing for better and faster decisions in a wide range of areas, such as financial services and healthcare. However, it can be challenging to explain and interpret the predictions of ML models (also referred to herein simply as models), including, in particular, models that take as an input a series of sequential events. Thus, it would be beneficial to develop techniques directed toward explaining predictions of models that operate on sequential input data.

### BRIEF DESCRIPTION OF THE DRAWINGS

Various embodiments of the invention are disclosed in the following detailed description and the accompanying drawings.

FIG. 1a is a diagram illustrating an embodiment of a framework for explaining a recurrent model's predictions.

FIG. 2 is a diagram illustrating an example of input data representing a sequence of events and their associated features.

FIG. 3 is a flow diagram illustrating an embodiment of a process for analyzing relevance of selected event data in producing a prediction output of a machine learning model.

FIG. 4a is a flow diagram illustrating an embodiment of a process for determining event data to lump together to reduce computational complexity.

FIG. 4b is a diagram illustrating an example of lumped event data.

FIG. 5a is a flow diagram illustrating an embodiment of a process for determining cell-level groupings for a perturbation analysis.

FIG. 5b is a diagram illustrating an example of cell-level groupings.

FIG. 6 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A series of sequential inputs and a prediction output of a machine learning model, to be analyzed for interpreting the prediction output, are received. An input included in the series of sequential inputs is selected to be analyzed for relevance in producing the prediction output. Background data for the selected input of the series of sequential inputs to be analyzed is determined. The background data is used as a replacement for the selected input of the series of sequential inputs to determine a plurality of perturbed prediction outputs of the machine learning model. A relevance metric is determined for the selected input based at least in part on the plurality of perturbed prediction outputs of the machine learning model. In various embodiments, background data is uninformative information (e.g., an average value in some scenarios and a zero value in other scenarios). In various embodiments, interpreting the prediction output involves generating model output explanations based on perturbations and their impact on model score, wherein the perturbations are calculated by imputing a value based on the background data. The imputation may be based on a training dataset and represents an uninformative feature value to the model (e.g., an average value of a feature).

Machine learning has been widely utilized to aid decision-making in various domains, e.g., healthcare, public policy, criminal justice, finance, etc. Understanding the decision process of ML models is important for instilling confidence in high-stakes decisions made by ML models. Oftentimes, these decisions have a sequential nature. For instance, a transaction history of a credit card can be considered when predicting a risk of fraud of the most recent transaction. Recurrent neural networks (RNNs) are state-of-the-art models for many sequential decision-making tasks, but they can result in a black-box process in which it is difficult for decision-makers (end users) to understand the underlying decision process, thereby hindering trust. Prior explanation methods for ML have not sufficiently focused on recurrent models (e.g., RNNs). A model-agnostic recurrent explainer that can explain any model that uses a sequence of inputs to make a decision is disclosed herein. Techniques disclosed herein include techniques to explain recurrent models by computing feature, timestep (also referred to herein as event), and cell-level attributions, producing explanations at feature, event, and cell levels. As sequences of events may be arbitrarily long, techniques to lump events together to decrease computational cost and increase reliability are also disclosed herein. Thus, technological advantages of the techniques disclosed herein include improving ML explanation analysis for recurrent models, reducing computational cost of ML model explanation analysis, and increasing reliability of ML model explanation analysis.

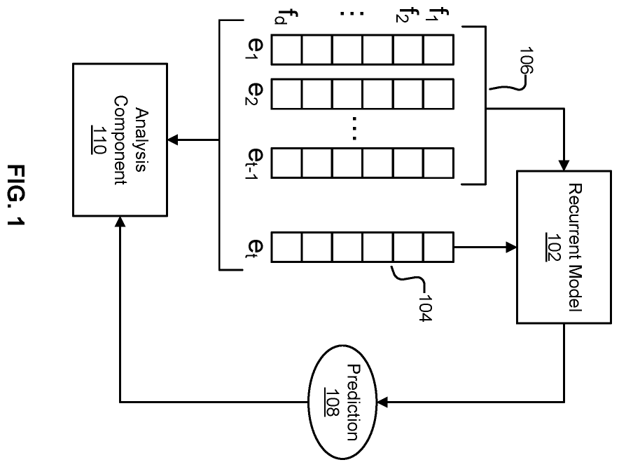

FIG. 1a is a diagram illustrating an embodiment of a framework for explaining a recurrent model's predictions. In the example illustrated, the predictions of recurrent model 102 are explained. The framework illustrated is applicable to any model that encodes sequences. For example, recurrent model 102 may include an RNN model. Examples of RNN models include long short-term memory (LSTM) networks and gated recurrent unit (GRU) networks. The techniques disclosed herein are also applicable to random forest models and various other models that encode sequences. In the example illustrated, recurrent model 102 receives input 104 and hidden state 106 to generate prediction 108. In the example shown, prediction 108 at a given time-step t is a function not only of a current input event eₜ (input 104) but also of previous input events at previous time-steps. For recurrent model 102, this recurrence is achieved indirectly through a hidden state that encodes all relevant information from previous time-steps (hidden state 106). In the example shown, hidden state 106 is schematically depicted as being a function of input events from time-step t−1 through time-step 1.

In the example illustrated, each input event (e.g., eₜ corresponding to input 104) is comprised of d features (f₁, f₂, . . . f_{d}). Recurrent model 102 encodes information along two axes: a sequence (or time/event) axis (e₁ to eₜ) and a feature axis (f₁ to f_{d}). For embodiments in which recurrent model 102 is configured to detect account takeover, fraud, inappropriate account opening, money laundering, or other non-legitimate account activity, examples of events include enrollments, logins, and other transactions performed for a specific user and/or account, and examples of features include transaction type, transaction amount, Internet Protocol (IP) address and related information, virtual and physical location information, billing address, time/day of the week, user age, and various other information. In this setting, an example of prediction 108 is a quantification (e.g., likelihood) of a decision label (e.g., account takeover, fraud, illegitimate activity, etc.) associated with a transaction corresponding to input 104. As another example, in a medical diagnosis setting, examples of events include current and past medical visits, hospitalizations, diagnoses, treatments, and so forth, and examples of features include vital signs measurements, reactions to treatment, length of hospital stay, and other information collected for each event. In this setting, an example of prediction 108 is a quantification (e.g., likelihood) of a decision label (e.g., diabetes, cancer, etc.) associated with input 104.

In the example illustrated, analysis component 110 analyzes and explains prediction 108. As used herein, explanation of a machine learning model prediction refers to analysis of a machine learning model via techniques and algorithms that allow humans to interpret, understand, and trust machine learning model predictions. Explanation of machine learning models is also referred to as explainable artificial intelligence (XAI). An explanation, in the context of XAI, is an interpretable description of a model behavior, wherein the meaning of “interpretable” depends on the recipient of the explanation (e.g., interpretable to a data scientist, consumer, etc.). Together with being interpretable to an end-user, an explanation must be faithful to the model being explained, representing its decision process accurately. In some embodiments, explanations include feature importance scores, where each input feature is attributed an importance score that represents its influence on the model's decision process. In various embodiments, explanations are post-hoc in that the explanations are for previously trained models. Post-hoc techniques can be designed to explain any machine learning model, in which case, they are also model-agnostic techniques.

In various embodiments, analysis component 110 utilizes a post-hoc, model-agnostic technique to explain prediction 108. In various embodiments, input perturbations are utilized to determine how model outputs react to different input perturbations, and explanations are extrapolated through this output and input perturbation relationship. In various embodiments, a dataset of perturbations is created and scored by the machine learning model to be explained. Given the perturbation dataset together with the respective scores, the behavior of the machine learning model is understood in terms of reactions to different perturbations. The perturbation analysis can be conducted according to a game theory-based framework involving calculation of Shapley values. Shapley values refer to a solution to fairly distribute a reward across players of a cooperative game. With respect to XAI, a model's prediction score can be regarded as the reward in the cooperative game, and the different input components to the model can be regarded as the players of the cooperative game. Thus, determining Shapley values for the different input components can be regarded as determining the relative importance of the different input components in causing the prediction score.

An advantage of bringing the Shapley values framework into model interpretability is inheriting Shapley properties for model explanations, these being: local accuracy ensuring that the sum of all individual input attribution values is equal to the model's score; missingness dictating that missing inputs should have no impact on the model's score, and therefore their attribution must be null; and consistency ensuring that if an input's contribution to the model increases, then its attributed importance should not decrease. The Shapley value of each input represents the marginal contribution of that input toward the final prediction score. The marginal contribution of an input component i corresponds to forming a coalition (a grouping) of a number of input components without input component i, scoring it, and then adding input component i to that same coalition and scoring it again. The marginal contribution of input component i to the formed coalition will be the difference in score caused by adding input component i. In a traditional game theory sense, the Shapley value for input component i is calculated by determining an average of the marginal contributions of input component i across all possible coalitions that can be formed without input component i. For example, for a machine learning model that receives input components A, B, C, and D, the Shapley value for input component A (in the traditional game theory sense) would require calculating marginal contributions to the following coalitions: {B}, {B, C}, {B, D}, {B, C, D}, {C}, {C, D}, and {D}. A problem with calculating Shapley values in the traditional game theory sense is that the number of coalitions required increases exponentially with the number of input components to the machine learning model to the point of being computationally intractable for the number of input components typically received by machine learning models. Thus, in various embodiments, a sampling of N (a specified parameter) coalitions can be formed (representing N perturbations) instead of attempting to form every possible coalition. The sampling may be a random sampling. As used herein with respect to the disclosed techniques, Shapley values can refer to approximations of exact Shapley values based on a sampling of coalitions. Shapley values can also refer to exact Shapley values.

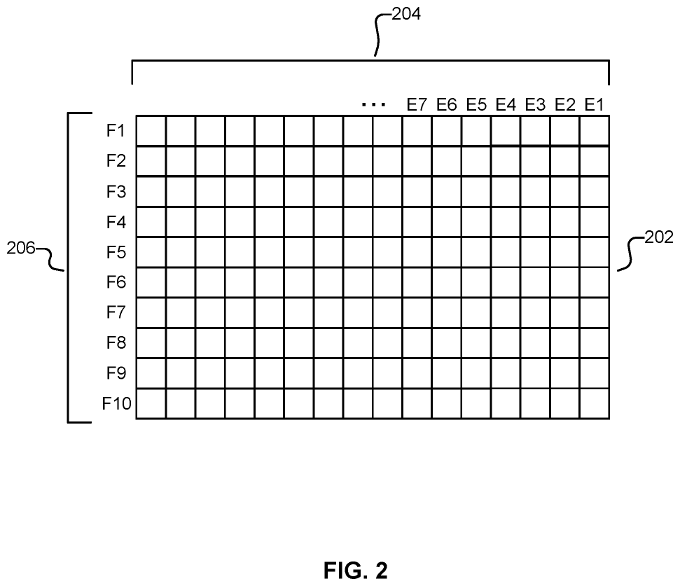

In the example illustrated, analysis component 110 determines various coalitions of input components for recurrent model 102 to score to determine Shapley values for different input components. Recurrent model 102 scores each coalition of input components by processing that coalition in inference mode and generating an output (e.g., a prediction score). Analysis component 110 is communicatively connected to recurrent model 102 (though, this connection is not drawn in FIG. 1 for the sake of illustrative clarity). Furthermore, in various embodiments, in explaining prediction 108, analysis component 110 has access to all event data (events e₁, e₂, . . . eₜ₋₁, eₜ) as opposed to merely input 104 and a hidden state representation of events e₁, e₂, . . . eₜ₋₁ that recurrent model 102 receives. Stated alternatively, in various embodiments, all events (e.g., in a fraud detection context, corresponding to various user enrollments, logins, transactions, and so forth) have been stored (along with feature data for each event) and can be accessed for individual analysis by analysis component 110. It is also possible for analysis component 110 to be configured to have access to and operate on event data for a specified number of most recent events (e.g., 5, 10, 20, etc.) and a hidden state representation for the rest of the event data. This may be due to having limited storage for individual event data. Computing resources can be conserved by grouping and representing older events together. Further description of utilizing a Shapley values framework to provide feature and event explanations (e.g., determine relevance of different features and events with respect to a machine learning model prediction) is given below (e.g., see discussion associated with FIG. 2).

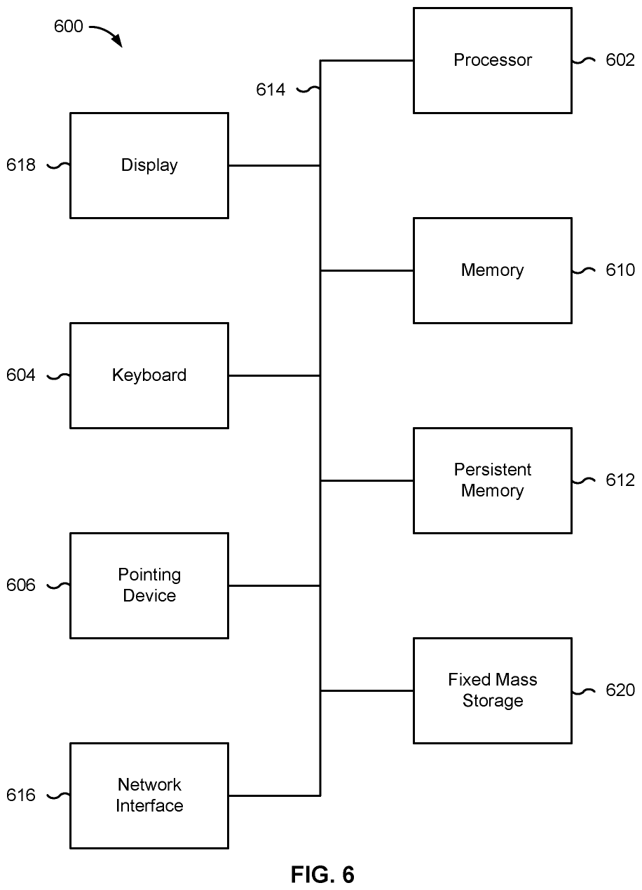

In the example shown, portions of the communication path between the components are shown. Other communication paths may exist, and the example of FIG. 1 has been simplified to illustrate the example clearly. For example, in various embodiments, recurrent model 102 and analysis component 110 are communicatively connected. Although single instances of components have been shown to simplify the diagram, additional instances of any of the components shown in FIG. 1 may exist. The number of components and the connections shown in FIG. 1 are merely illustrative. Components not shown in FIG. 1 may also exist. In some embodiments, at least a portion of the components in FIG. 1 (e.g., recurrent model 102 and/or analysis component 110) are implemented in software. In some embodiments, at least a portion of the components in FIG. 1 (e.g., recurrent model 102 and/or analysis component 110) are comprised of computer instructions executed on computer system 600 of FIG. 6. It is also possible for at least a portion of the components of FIG. 1 to be implemented in hardware, e.g., in an application-specific integrated circuit (ASIC) or a field programmable gate array (FPGA).

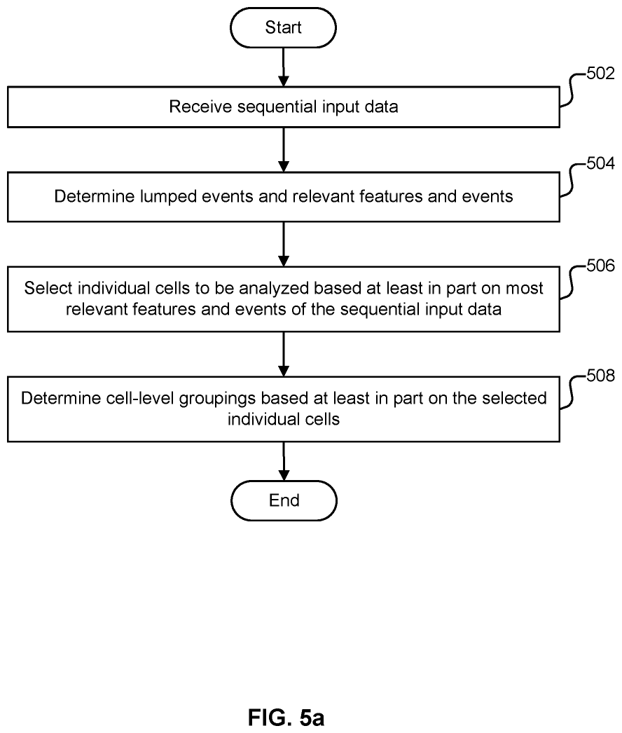

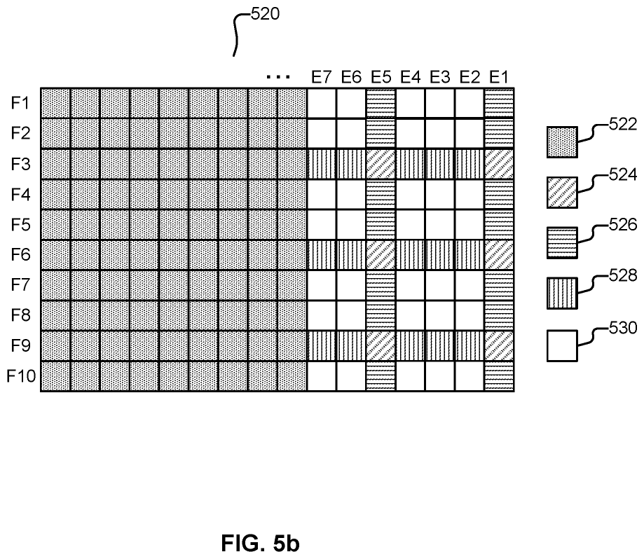

FIG. 2 is a diagram illustrating an example of input data representing a sequence of events and their associated features. In the example illustrated, input data 202 is bi-dimensional in that it is comprised of a two-dimensional matrix of data elements defined by events 204 and features 206. Input data 202 may be utilized by analysis component 110 of FIG. 1 in a Shapley values perturbation analysis to determine relevance of various elements of input data 202 in causing an output of a machine learning model (e.g., recurrent model 102 of FIG. 1). Events 204 include events E1, E2, E3, E4, E5, E6, and E7, with event E1 being the most recent event (e.g., corresponding to input 104 of FIG. 1) and the other events being events that occurred prior to E1. A recurrent model (e.g., recurrent model 102 of FIG. 1) generating a prediction output based on input data 202 would thus generate a prediction output based on an input of E1 and a hidden state representation of the other events of events 204. In the example shown, each event is associated with a plurality of features F1 through F10. The number of events and features shown is illustrative and not restrictive. For example, it is possible to have more than the 10 features shown. Within a perturbation analysis framework (e.g., using Shapley values as described with respect to FIG. 1), explanation of the prediction output can be with respect to events and/or features, which is described in further detail herein. Stated alternatively, explanations can be produced on both axes of input data 202 to assess which events are the most relevant as well as which features across the events are the most relevant. It is also possible to determine a most relevant feature of a most relevant event for cell-level explanation (e.g., see FIGS. 5a and 5b).

The techniques disclosed herein, using Shapley values, explain an instance x by approximating the local behavior of a complex model f with an interpretable model g. The learning of this explainable model g is framed as a cooperative game where a reward (f(x), the score of the original model) is distributed fairly across d input components of the model to be explained. A consequence of this approach is that a model works with a fixed number of input components d; therefore, it is unable to evaluate coalitions with different sizes than what it was trained on. To address this, in various embodiments, when an input component is set to be missing from a coalition, it assumes an uninformative background value, b, representing its removal. In various embodiments, b is an average value for the input component (e.g., average during training of the model). In some scenarios, b may be a zero value.

A discussion of a one-dimensional Shapley approach is informative and is the basis for the bi-dimensional approach described below. To find Shapley values for an instance x∈ [symbol] ^{d} (comprising only one-dimensional data, such as only feature data), coalitions of input components z∈{0,1}^{d} are formed in order to obtain input component attribution values, such that zᵢ=1 means that input component i is present and zᵢ=0 represents the absence of input component i. An input perturbation function can be formally written as: hₓ(z)=x⊙z+b⊙(1−z) (Equation 1), where ⊙ is the element-wise product. The vector b∈ [symbol] ^{d} represents uninformative input component values, such as average values in the input dataset (b₁=x̅ᵢ) or the zero vector (b=0_{d}). This perturbation approach can be utilized to approximate the local behavior of a complex model f (the machine learning model) with an interpretable linear model of input component importance g, such that g (z)≈f(hₓ(z)). In various embodiments, coalitions of input components z and the respective input perturbations hₓ are calculated and then a linear regression model is fitted to the binary coalitions z approximating the model scores f(hₓ(z)). A formula for g can be written as f(hₓ(z))≈g(z)=ω₀+Σᵢ₌₁^{d}ωᵢzᵢ (Equation 2), where the bias term ω₀=f(hₓ(0)) corresponds to the model's output with all input components turned off (e.g., average values), which is referred to as the base score and the weights ω₁, i∈{1, . . . , d} correspond to Shapley values that are interpreted as the importance of each input component. The sum of all input component importance values (Shapley values) corresponds to and explains the difference between the model's score for the original instance f(x)=f(hₓ(1)) and the base score f(hₓ(0)).

In many scenarios, the generation of all possible coalitions z∈{0, 1}^{d} is not feasible because such a computation scales exponentially with d. In various embodiments, exact Shapley values are not calculated, and instead, approximations are computed by randomly sampling a specified number of coalitions. The introduction of this sampling introduces a stochastic aspect to the technique, revealing a tension between computational cost and variance of the explanations (the higher the number of sampled coalitions, the lower the variance, but the higher the computational cost). In some embodiments, approximations to the exact Shapley values are determined based on a coalition weighting kernel, πₓ(z), and a single loss metric, L(f, g, πₓ), where

$${π}_{x} ( z ) = \frac{( d - 1 )}{( \begin{matrix}d \\ \vert z \vert\end{matrix} ) \vert z \vert ( d - \vert z \vert )} \qquad ( Equation 3 )$$

and L(f, g, πₓ)=Σ_{z∈{0,1}}_{^{d}} [f(hₓ(z))−g(z)]² πₓ(z) (Equation 4), respectively. In these equations, |z| is the number of non-zero elements of z, and L is the squared error loss used for learning g. In various embodiments, the coalitions are randomly sampled following the weight they will receive from the kernel πₓ(Z) to ensure that coalitions that provide more information to the calculation are more likely to be sampled. In some embodiments, Equation 4 is computed using weighted linear regression. The solution to Equation 4 is the interpretable model g with the formulation presented in Equation 2. The explanation extracted from g are the learned coefficients ωᵢ (the calculated Shapley values).

In various embodiments, the above one-dimensional Shapley approach is adapted for the bi-dimensional data of input data 202 (data applicable to a recurrent model setting). Because input data 202 includes two axes, a feature axis and a sequence (time, event, etc.) axis, uninformative background values are also in a two-dimensional form. In various embodiments, an uninformative background instance, B, for input data 202 is a matrix of the same size as input data 202. In general, if input data 202 has d features and l events, then B would be a d×l matrix. In some embodiments, B is defined as:

$$[ \begin{matrix}\overline{{x}_{1}} & ⋯ & \overline{{x}_{1}} \\ ⋮ & ⋱ & ⋮ \\ \overline{{x}_{l}} & ⋯ & \overline{{x}_{l}}\end{matrix} ] , \qquad ( Equation 5 )$$

where each element of B is the average value of the corresponding feature from a training dataset. For example, in the first row of B, each element is the average value of the first feature, x̅₁̅. As with the one-dimensional case, to explain the d×l data of input data 202, a linear explainer g can be fitted by minimizing the loss given in Equation 4. Because events are simply features along the temporal dimension, Equation 2 is still applicable. For the two-dimensional case, Equation 2 can be generalized to: f(h_{X}(z))≈g(z)=ω₀+Σᵢ₌₁^{m}ωᵢzᵢ (Equation 6), where the bias term ω₀=f(h_{X}(0)) corresponds to the model's output with all input components (features and events) toggled off (the base score), the weights ωᵢ, i∈{1, . . . , m} correspond to the importance of each input component, and m can equal d when explaining based on the feature dimension, equal l when explaining based on the event dimension, or equal another value when explaining based on another grouping pattern.

With respect to the interpretable model g in Equation 6, the input is the coalition vector z and its target variable is the score of the model being explained. To build this linear model, only two factors are required: the coalition vector z and the respective coalition score f(h_{X}(z)). Thus, by controlling the coalition vector z and the perturbation function h(z), it is possible to fully control which features and/or events are being explained. For feature-wise explanations, given a d×l matrix B representing an uninformative input, a perturbation h_{X}^{f} along the features axis (the rows) of input data 202 is the result of mapping a coalition vector z∈{0, 1}^{d} to input data 202. As features are rows of the input matrix X (input data 202), zᵢ=1 means that row i takes its original value X_{i,:}, and zᵢ=0 means that row i takes the uninformative background value B_{i,:}. Thus, when zᵢ=0, the feature i is toggled off for all events of the sequence. This is formalized as follows: h_{X}^{f}(z)=D_{z}X+(I−D_{z})B (Equation 7), where D_{z} is the diagonal matrix of z and I is the identity matrix. For event-wise explanations, a perturbation h_{X}^{e} along the events axis (the columns) of input data 202 is the result of mapping a coalition vector z∈{0,1}^{l} to input data 202. As events are columns of the input matrix X (input data 202), zⱼ=1 means that column j takes its original value X_{:,j}, and zⱼ=0 means that column j takes the uninformative background value B_{:,j}. Thus, when zⱼ=0, all features of event j are toggled off. This is formalized as follows: h_{X}^{e}(z)=XD_{z}+B(I−D_{z}) (Equation 8), where D_{z} is the diagonal matrix of z and I is the identity matrix. Hence, when explaining features, h_{X}=h_{X}^{f}, and when explaining events, h_{X}=h_{X}^{e}. Moreover, the perturbation of X according to a null-vector coalition z=0 is the same regardless of which dimension is being perturbed, h_{X}^{f}(0)=h_{X}^{e}(0), and equally for z=1, h_{X}^{f}(1)=h_{X}^{e}(1). As used herein, toggling on/off can also be referred to as activating/inactivating or taking an original value/taking a background value.

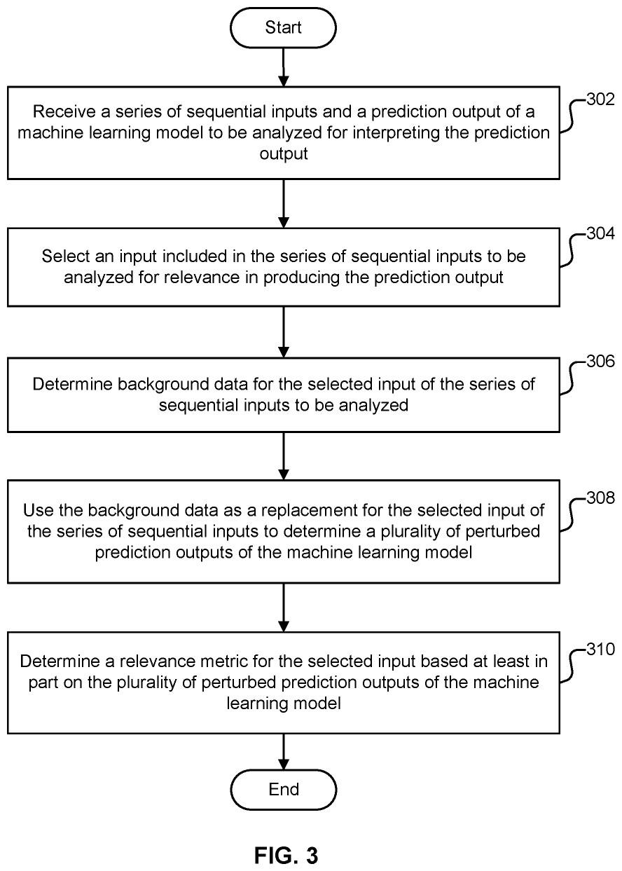

FIG. 3 is a flow diagram illustrating an embodiment of a process for analyzing relevance of selected event data in producing a prediction output of a machine learning model. In some embodiments, event data of input data 202 of FIG. 2 is analyzed. In some embodiments, the process of FIG. 3 is performed by analysis component 110 of FIG. 1.

At 302, a series of sequential inputs and a prediction output of a machine learning model, to be analyzed for interpreting the prediction output, are received. In some embodiments, the series of sequential inputs are comprised of events 204 of FIG. 2. The series of sequential inputs correspond to temporally separated data points, e.g., data for transactions of an account holder over time, medical visits by a patient over time, etc. In some embodiments, the prediction output is prediction 108 of FIG. 1. In some embodiments, the machine learning model is recurrent model 102 of FIG. 1.

At 304, an input included in the series of sequential inputs is selected to be analyzed for relevance in producing the prediction output. An example of the selected input is a specific event (e.g., E1, E2, E3, E4, E5, E6, or E7, etc. of events 204 of FIG. 2). In various embodiments, each event is comprised of a plurality of features (e.g., features 206 of FIG. 2).

At 306, background data for the selected input of the series of sequential inputs to be analyzed is determined. In some embodiments, the background data comprises one or more uninformative data values, e.g., average values of machine learning model training data associated with the selected input. In some embodiments, the background data is a vector of values. For example, the background data for a column of data (an event) of a bi-dimensional input data matrix (e.g., input data 202 of FIG. 2) may be a column of B in Equation 5.

At 308, the background data is used as a replacement for the selected input of the series of sequential inputs to determine a plurality of perturbed prediction outputs of the machine learning model. In various embodiments, replacing the selected input is a part of a perturbation analysis based on determining how the selected input contributes to the prediction output by examining various coalitions comprising other inputs of the series of sequential inputs but excluding the selected input. In various embodiments, these coalitions without the selected input are supplied to the machine learning model to determine the plurality of perturbed prediction outputs. Examining outputs of the machine learning model when the selected input is replaced by the background data generates information regarding the marginal contribution of the selected input to the prediction output.

At 310, a relevance metric is determined for the selected input based at least in part on the plurality of perturbed prediction outputs of the machine learning model. In various embodiments, the relevance metric is a Shapley value. When all potential coalitions that exclude the selected input are utilized to determine the plurality of perturbed prediction outputs, an exact Shapley value for the selected input can be determined by averaging the plurality of perturbed prediction outputs. However, in many scenarios, it is computationally intractable to utilize all of the potential coalitions to determine the plurality of perturbed prediction outputs. In various embodiments, a sampling of all potential coalitions that exclude the select input is utilized to determine an approximation to the exact Shapley value. In some embodiments, the approximation to the exact Shapley value is determined based on the coalition weighting kernel and loss metric of Equations 3 and 4, respectively.

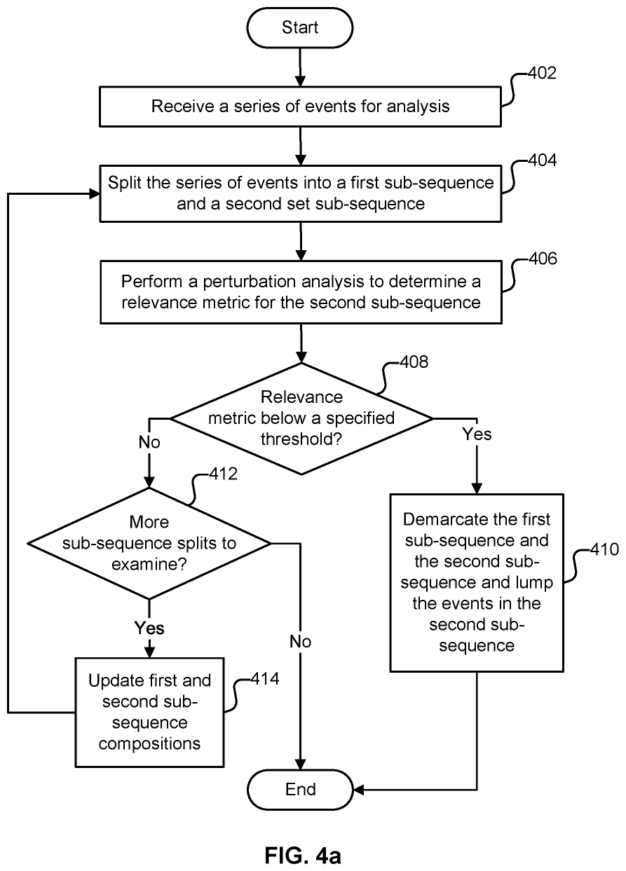

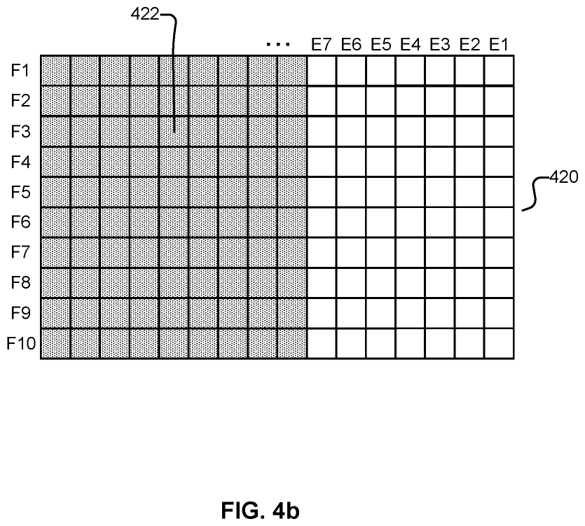

FIG. 4a is a flow diagram illustrating an embodiment of a process for determining event data to lump together to reduce computational complexity. One issue with the techniques disclosed above is the potential for exponential growth of the number of coalitions with the number of features and/or events being explained. As described above, an approach to handle this issue is to implement random sampling of a specified number of coalitions to test. This random sampling introduces a stochastic component, which introduces variance into the results when not all coalitions are tested. This variance can be mitigated by increasing the number of sampled coalitions, but that incurs a computational cost. This issue is exacerbated in the recurrent setting, which is associated with event-level and cell-level explanations, because the coalition number scales exponentially with the sequence length and the input sequence can be arbitrarily long. Thus, in various embodiments, a pruning (also referred to herein as lumping, combining, etc.) approach is employed to reduce coalition numbers associated with sequence length. In some embodiments, the process of FIG. 4a is performed by analysis component 110 of FIG. 1. In some embodiments, the process of FIG. 4a is utilized to prune the series of sequential inputs described in 302 of FIG. 3. Pruning can be advantageous because in many scenarios, it is common for a current event to be preceded by a long history of past events, with only a few of these past events being relevant to the current prediction. Furthermore, recurrent models oftentimes encode little information from the distant past.

At 402, a series of events is received for analysis. In some embodiments, the series of events is events 204 of FIG. 2 and/or the series of sequential inputs in 302 of FIG. 3. FIG. 4b illustrates an example series of events from a two-dimensional matrix of data resembling input data 202 of FIG. 2. In FIG. 4b, matrix 420 comprises an arbitrarily long sequence of events starting with current event E1, older event E2, next older event E3 (E3 being older than E2), and so forth. In the example illustrated, each event includes features F1 through F10.

At 404, the series of events is split into a first sub-sequence and a second sub-sequence. In various embodiments, initially, the first sub-sequence is composed of only the most recent event in the series of events (e.g., E1 of matrix 420 of FIG. 4b) and the second sub-sequence is composed of the rest of the events in the series of events. As described below, the composition of events in the first and second sub-sequences can be updated iteratively.

At 406, a perturbation analysis is performed to determine a relevance metric for the second sub-sequence. In some embodiments, the relevance metric is an exact Shapley value. The relevance metric for the second sub-sequence corresponds to the relative importance of the second sub-sequence (compared to the first sub-sequence) in explaining a prediction output. In various embodiments, the perturbation analysis involves using the temporal perturbation function h_{X}^{e}(z) in Equation 8 to determine an exact Shapley value for the second sub-sequence. Because there are only two elements in the set of sub-sequences, there are only four possible coalitions (combinations of the presence or absence of the first sub-sequence and/or the second sub-sequence) that can be formed. Because of this small, finite number of possible coalitions, it is possible to rapidly and efficiently compute the exact Shapley values for the first sub-sequence and the second sub-sequence. Thus, the relevance metric for the second-sub sequence can be rapidly and efficiently determined.

At 408, it is determined whether the relevance metric falls below a specified threshold. The specified threshold may take the form of a specific importance value that is empirically decided. The specified threshold may also take the form of a ratio of an importance value associated with the second sub-sequence to an importance value associated with the overall sequence of predictions (e.g., a ratio of Shapley values).

If it is determined at 408 that the relevance metric falls below the specified threshold, at 410, the first sub-sequence and the second sub-sequence are demarcated and the events in the second sub-sequence are lumped together. For example, consider the initial state of the first sub-sequence being composed of only the most recent event (e.g., E1 in FIG. 4b) and the second sub-sequence being composed of the rest of the events. If, at this point, the relevance metric for the second sub-sequence falls below the specified threshold, this indicates that all events other than the most recent event can be grouped together as a single collection of events because their collective importance is not significant compared to the importance of the most recent event in explaining the prediction output. In various embodiments, the events of the second sub-sequence are lumped together and considered a single input in the series of sequential inputs considered in 304 of FIG. 3.

If it is determined at 408 that the relevance metric does not fall below the specified threshold, at 412, it is determined whether more sub-sequence splits are available to examine. In various embodiments, as described in 414 below, sub-sequence splits are updated by moving the most recent event not already in the first sub-sequence from the second sub-sequence to the first sub-sequence. If it is possible to update the sub-sequence splits according to this operation, then there are more sub-sequence splits to examine. If all events have been moved to the first sub-sequence (no events in the second sub-sequence), then there are no further sub-sequence splits to examine and the process of FIG. 4a ends.

If it is determined at 412 that there are more sub-sequence splits to examine, at 414, the first and second sub-sequence compositions are updated. With respect to the example shown in FIG. 4b, when 414 occurs after the initial stage split of E1 in the first sub-sequence and the rest of the events in the second sub-sequence, the first sub-sequence is updated to be composed of events E1 and E2 and the second sub-sequence is updated to be composed of the remaining events. This corresponds to recognizing that the second sub-sequence needs to be further limited in order to determine a collection of past events for which the corresponding relevance metric will fall below the specified threshold. After updating the sub-sequence compositions, 404, 406, and 408 are repeated with the updated sub-sequence splits. In many cases, after a sufficient number of consecutive events are moved from the second sub-sequence, the importance of the second sub-sequence will be insignificant in terms of explaining the prediction output (according to the relevance metric as compared with the specified threshold) and the events in the second sub-sequence can be lumped together according to 410. In the example shown in FIG. 4b, this occurs after adding event E7 to the first sub-sequence, and portion 422 of matrix 420 is treated as a single coalition for subsequent prediction output explanation analysis. In the process of FIG. 4a, older (unimportant) events are grouped as a single coalition of events, thereby reducing the number of coalitions by a factor of 2^{l-i+1}, where i is the number of grouped events of a sequence with l elements. Explanation granularity on older unimportant events (according to a threshold for importance) is sacrificed in favor of runtime improvements and of increased precision of explanations for important events. The process of FIG. 4a is illustrative and not restrictive. Other pruning methods are also possible (e.g., directly searching for a smallest sub-sequence of recent events that matches the model's original score within a specified tolerance).

FIG. 4b is a diagram illustrating an example of lumped event data. FIG. 4b is described above in the description associated with FIG. 4a.

FIG. 5a is a flow diagram illustrating an embodiment of a process for determining cell-level groupings for a perturbation analysis. As described above (e.g., with respect to FIG. 2), it is possible to provide both event-level explanations, e∈ [symbol] ^{l}, and feature-level explanations, f∈ [symbol] ^{d}. These explanations indicate which columns (events) and features (rows) of an input matrix X∈ [symbol] ^{d×l} are most relevant for a model prediction. These explanations, however, do not inform as to whether all features in the relevant events are equally important or whether the most relevant features are equally as important in all events. In order to address these questions, explanations at a cell-level (a cell being a feature of an event) are required, indicating the most relevant features at particular events. In some embodiments, the process of FIG. 5a is performed by analysis component 110 of FIG. 1. In some embodiments, the process of FIG. 5a is performed in conjunction with the process of FIG. 3 to explain a machine learning model at a cell-level granularity.

For cell-level explanations, given a background matrix B∈ [symbol] ^{d×l}, defined in Equation 5, a perturbation h_{X}^{cl} of an input matrix X∈ [symbol] ^{d×l} is the result of mapping a coalition matrix Z∈{0,1}^{d×l} to the original input space, such that Z_{i,k}=1 means that cell x_{i,k} takes its original value X_{i,k}, and Z_{i,k}=0 means that cell x_{i,k} takes its uninformative background value B_{i k}. Thus, when Z_{i,k}=0, cell x_{i,k} is toggled off. This is formalized as: h_{X}^{cl}(Z)=X⊙Z+(J−Z)⊙B (Equation 9), where ⊙ represents the Hadamard product, Z is the coalition matrix, and J∈{1}^{d×l} is a matrix of ones with d rows and l columns.

At 502, sequential input data is received. In some embodiments, this input data is input data 202 of FIG. 2 and/or matrix 420 of FIG. 4b. In various embodiments, the input data is an input matrix X∈ [symbol] ^{d×l}. For cell-level explanations, even with a modest number of rows and columns, the number of potential coalitions can present intractable computations because the number of coalitions scales exponentially with d×l (the number of cells). In various embodiments, in order to obtain reliable cell-level explanations, the number of considered cells is drastically reduced. Because older events in sequential inputs are rarely relevant, the pruning (lumping) process of FIG. 4a can be applied to the input data to reduce the total number of coalitions from O(2^{dl}) to O(2^{d(l-i)+1}), with i being the number of events lumped together. This lumping may be performed after the input data is received. It is also possible for the input data to already reflect the lumping. In many scenarios, although the impact of lumping is substantial, further decreasing the number of possible coalitions is required for reliable computation. Steps for further decreasing the number of possible coalitions are described below. FIG. 5b illustrates an example of an input matrix with different cell-level groupings, including lumped cells. In input matrix 520 of FIG. 5b, lumped cells are filled with pattern 522.

At 504, lumped events and relevant features and events are determined based on the input data. In some embodiments, the lumped events are determined according to the process of FIG. 4a. In various embodiments, determining relevant features includes determining relevance metrics (e.g., Shapley values) for features in a feature-wise analysis and determining relevant events includes determining relevance metrics (e.g., Shapley values) for events in an event-wise analysis. In some embodiments, features and/or events are determined to be relevant if their corresponding relevance metrics (e.g., Shapley values) exceed a specified threshold.

At 506, individual cells to be analyzed are selected based at least in part on most relevant features and events from the determined relevant features and events. In some embodiments, the most relevant features and events are a specified number of highest relevance features and events or those exceeding a specified threshold of relevance. In various embodiments, relevance is determined according to a relevance metric (e.g., Shapley value). In some embodiments, the selected individual cells are the intersections of the determined relevant features and the determined relevant events. In many scenarios, there is a high chance the most significant cells are those at the intersection of the most significant rows (features) and most significant columns (events). Input matrix 520 of FIG. 5b illustrates such selected individual cells. In the example shown in FIG. 5b, features F3, F6, and F9 are the determined relevant features, and events E1 and E5 are the determined relevant events. Their intersections, the selected individual cells, are indicated by pattern 524. If all that is done is to select the cells in the above manner, the number of considered groupings of sequence X∈ [symbol] ^{d×l}, with/events and d features per event, is reduced from dl (considering all cells) to fe+2, where f and e are the number of relevant features and events, respectively, and the additional number 2 represents the lumped events grouped together and the remaining (unimportant) cells grouped together.

At 508, cell-level groupings are determined based at least in part on the selected individual cells. In many scenarios, simply utilizing the fe+2 groupings described above has the drawback of losing attributions of non-intersection cells. Because it is likely that there are other relevant cells in the most relevant rows and columns besides the intersection cells, in various embodiments, non-intersection cells of relevant events are grouped together (illustrated in FIG. 5b as the cells with pattern 526) and non-intersection cells of relevant features are grouped together (illustrated in FIG. 5b as the cells with pattern 528). This allows for finer granularity of explanations while not overly increasing computational cost. The remaining cells are grouped together as remaining non-relevant cells (illustrated in FIG. 5b as the cells with pattern 530). An advantage of this cell grouping strategy is a good trade-off between cell granularity and computational cost. The number of considered cells with this strategy is fe+f+e+2, where f and e are the number of relevant features and events, respectively, and the additional number 2 represents the lumped events grouped together and the remaining (unimportant) cells grouped together. As opposed to event-wise and feature-wise explanations, each element of a coalition vector z does not map directly into a column or a row. Instead, each zᵢ∈z maps to a different cell group (e.g., those illustrated in FIG. 5b).

In various embodiments, a perturbation analysis is performed using the above cell groupings. Calculating a cell-wise perturbation h_{X}^{c} of an input matrix X∈ [symbol] ^{d×l} is a result of mapping a coalition z to the original input space [symbol] ^{d×l} such that zᵢ=1 means that cell group i takes its original value and zᵢ=0 means that cell group i takes the corresponding uninformative background value (uninformative background value derived from B∈ [symbol] ^{d×l} defined in Equation 5).

FIG. 5b is a diagram illustrating an example of cell-level groupings. FIG. 5b is described above in the description associated with FIG. 5a.

FIG. 6 is a functional diagram illustrating a programmed computer system. In some embodiments, the process of FIG. 3, the process of FIG. 4a, and/or the process of FIG. 5a is executed by computer system 600. In some embodiments, analysis component 110 of FIG. 1 is implemented as computer instructions executed by computer system 600.

In the example shown, computer system 600 includes various subsystems as described below. Computer system 600 includes at least one microprocessor subsystem (also referred to as a processor or a central processing unit (CPU)) 602. Computer system 600 can be physical or virtual (e.g., a virtual machine). For example, processor 602 can be implemented by a single-chip processor or by multiple processors. In some embodiments, processor 602 is a general-purpose digital processor that controls the operation of computer system 600. Using instructions retrieved from memory 610, processor 602 controls the reception and manipulation of input data, and the output and display of data on output devices (e.g., display 618).

Processor 602 is coupled bi-directionally with memory 610, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also, as is well known in the art, primary storage typically includes basic operating instructions, program code, data, and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

Persistent memory 612 (e.g., a removable mass storage device) provides additional data storage capacity for computer system 600, and is coupled either bi-directionally (read/write) or uni-directionally (read only) to processor 602. For example, persistent memory 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of fixed mass storage 620 is a hard disk drive. Persistent memory 612 and fixed mass storage 620 generally store additional programming instructions, data, and the like that typically are not in active use by the processor 602. It will be appreciated that the information retained within persistent memory 612 and fixed mass storages 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, pointing device 606 can be a mouse, stylus, track ball, or tablet, and is useful for interacting with a graphical user interface.

Network interface 616 allows processor 602 to be coupled to another computer, computer network, or telecommunications network using a network connection as shown. For example, through network interface 616, processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect computer system 600 to an external network and transfer data according to standard protocols. Processes can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a series of sequential inputs and a prediction output of a machine learning model to be analyzed for interpreting the prediction output;
selecting an input included in the series of sequential inputs to be analyzed for relevance in producing the prediction output;
determining background data for the selected input of the series of sequential inputs to be analyzed;
using the background data as a replacement for the selected input of the series of sequential inputs to determine a plurality of perturbed prediction outputs of the machine learning model; and
determining a relevance metric for the selected input based at least in part on the plurality of perturbed prediction outputs of the machine learning model.

2. The method of claim 1, wherein using the background data as the replacement for the selected input to determine the plurality of perturbed prediction outputs includes selecting different groupings of the replacement for the selected input combined with one or more other inputs from the series of sequential inputs to utilize in a perturbation analysis.

3. The method of claim 2, wherein the different groupings is a sampling from a total number of possible groupings combining the replacement for the selected input with other inputs from the series of sequential inputs.

4. The method of claim 1, further comprising including one or more inputs of the series of sequential inputs in a single input group for purposes of determining the plurality of perturbed prediction outputs.

5. The method of claim 4, wherein the single input group includes a portion of the series of sequential inputs that includes an oldest input of the series of sequential inputs.

6. The method of claim 5, wherein the single input group has a size that is determined based on determining a dividing point in the series of sequential inputs at which a group of inputs from the oldest input to a more recent input causes the relevance metric computed for the group of inputs to fail to meet a specified threshold.

7. The method of claim 1, wherein determining the relevance metric for the selected input includes calculating a weighted average associated with the different perturbed prediction outputs.

8. The method of claim 1, further comprising receiving a plurality of features for each input of the series of sequential inputs.

9. The method of claim 8, further comprising selecting a feature included in the plurality of features and determining background data for the selected feature.

10. The method of claim 9, further comprising using the background data for the selected feature as a replacement for the selected feature to determine a feature-specific plurality of perturbed prediction outputs of the machine learning model.

11. The method of claim 10, further comprising calculating the relevance metric for the selected feature based at least in part on the feature-specific plurality of perturbed prediction outputs of the machine learning model.

12. The method of claim 1, further comprising selecting a cell of data associated with the series of sequential inputs, wherein the cell of data corresponds to a specific feature of a specific input of the series of sequential inputs, and determining background data for the selected cell.

13. The method of claim 12, further comprising using the background data for the selected cell as a replacement for the selected cell to determine a cell-specific plurality of perturbed prediction outputs of the machine learning model.

14. The method of claim 13, further comprising calculating the relevance metric for the selected cell based at least in part on the cell-specific plurality of perturbed prediction outputs of the machine learning model.

15. The method of claim 1, wherein the replacement for the selected input is determined based on calculating an average associated with data samples utilized to train the machine learning model.

16. The method of claim 1, wherein the prediction output of the machine learning model is associated with a transaction being analyzed for detection of account takeover, fraud, inappropriate account opening, money laundering, or other non-legitimate account activity.

17. The method of claim 1, wherein the machine learning model includes a recurrent neural network.

18. The method of claim 17, wherein the recurrent neural network is a long short-term memory network or a gated recurrent unit network.

19. A system, comprising:
one or more processors configured to:
receive a series of sequential inputs and a prediction output of a machine learning model to be analyzed for interpreting the prediction output;
select an input included in the series of sequential inputs to be analyzed for relevance in producing the prediction output;
determine background data for the selected input of the series of sequential inputs to be analyzed;
use the background data as a replacement for the selected input of the series of sequential inputs to determine a plurality of perturbed prediction outputs of the machine learning model; and
determine a relevance metric for the selected input based at least in part on the plurality of perturbed prediction outputs of the machine learning model; and
a memory coupled to at least one of the one or more processors and configured to provide at least one of the one or more processors with instructions.

20. A computer program product embodied in a non-transitory computer readable medium and comprising computer instructions for:
receiving a series of sequential inputs and a prediction output of a machine learning model to be analyzed for interpreting the prediction output;
selecting an input included in the series of sequential inputs to be analyzed for relevance in producing the prediction output;
determining background data for the selected input of the series of sequential inputs to be analyzed;
using the background data as a replacement for the selected input of the series of sequential inputs to determine a plurality of perturbed prediction outputs of the machine learning model; and
determining a relevance metric for the selected input based at least in part on the plurality of perturbed prediction outputs of the machine learning model.
